(19) United States
(12) Patent Application Publication
(10) Pub. No.: US 2002/0067282 A1
(43) Pub. Date: Jun. 6, 2002

(54) Communication system for the disabled

(76) Inventors: Paul Andrew Moskowitz, Yorktown Heights, NY (US); Samuel Dinkin, Austin, TX (US); Stephen J. Boies, Mahopak, NY (US); William Grey, Millwood, NY (US); Philip Shin-Lung Yu, Chappaqua, NY (US); David Perry Greene, Ossining, NY (US)

Correspondence Address: George Sai-Halasz, 145 Fernwood Dr., Greenwich, RI, 02818, US

(21) Appl. No.: 09/730,818

(22) Filed: Dec. 6, 2000

(51) Int. Cl. H04Q 1/00

(52) U.S. Cl. 340/825.19; 359/142; 340/825.69

(57) ABSTRACT

A system and method for bettering the life of disabled persons whose mobility is impaired by using communication technology. Such technology allows the disabled control of his/her surrounding. The system and method comprises a wireless communication device associated with a wheelchair, or bed, and remote devices in the surroundings of the disabled person controlled by the wireless communication device. The present invention further provides for a standard protocol, such as Bluetooth, or IrDA for communication, and a selection policy for selecting a specific piece of device to communicate with.

### FIELD OF THE INVENTION

The present invention relates to the general area of helping the disabled to live a better life through the use of communication technology. More specifically, the present invention involves a system and method that allows disabled persons to control their environment though wireless communication.

### BACKGROUND OF THE INVENTION

Unfortunately, many persons who suffer from disease, or injury, such as to the spinal cord or the like, are left with limited mobility. Complications from these diseases and injuries can render a person wheelchair bound or bedridden. A person in this position, not only finds it difficult to enjoy the pleasures of life but also finds it difficult to accomplish simple tasks, such as controlling their immediate environment.

Numerous innovations for remote control devices have been provided in the prior art that will be described. Even though these innovations may be suitable for the specific individual purposes which they address, they differ from the present invention in that they do not teach how disabled persons may gain comfortable control of their environment.

For example, U.S. Pat. No. 4,168,594 to Tuchiya et al. teaches a remote controller for a hinged window that includes a flexible cable with one end operatively connected to a free end portion of the window.

In another example, U.S. Pat. No. 4,360,801 to Duhame teaches a home security and garage door operating system that includes a gas sensor for detecting the level of toxic gas in the garage.

In yet another example, U.S. Pat. No. 4,544,865 to Sharp teaches a window operating system that includes a motor control circuit for controlling the operation of direct current permanent magnet motors mounted on window operators associated with each window.

In a further example, U.S. Pat. No. 4,866,434 to Keenan teaches a multi-band universal remote control hand unit that stores compressed device control codes to make efficient use of the available memory space.

In one more example, U.S. Pat. No. 4,245,558 to Hachey teaches building computers specifically for the wheelchair bound.

In yet another example, U.S. Pat. No. 5,410,326 to Goldstein teaches a universal remote control device which is programmed to operate a variety of consumer products. The device is connected over a bi-directional link to either a cable convertor or a telephone interface for receiving programming information.

U.S. Pat. No. 5,782,036 to Beriberi, incorporated herein by reference, teaches controlling windows and appliances by remote means.

In a further example, U.S. Pat. No. 5,961,561 to Wakefiled teaches communication to remotely troubleshoot motorized wheelchairs. Control technology has been increasingly incorporated into motorized wheelchairs. It is now standard practice to incorporate controllers in motorized wheelchairs for controlling and monitoring various wheelchair functions such as forward speed, reverse speed, turning speed, acceleration, sensitivity, torque, braking, joystick commands, etc. As a result, the performance characteristics of each motorized wheelchair can be optimized for each user based on various criteria such as the user's desires, the user's physical capabilities, the type of environment or surroundings that the wheelchair will be operated in.

In a further example, Japanese Patent No. 4-106289 teaches an electric glass louver window controller wherein when the controller is manually operated, an electric glass louver window is selected in a required position.

In yet another example, Japanese Patent No. 4-202987 teaches a fully automatic window opening/closing device by hydraulic control that includes a control panel and a hydraulic unit arranged on a ceiling side, and an operation box at a normal position.

It is apparent that numerous innovations for remote control devices have been provided in the prior art that are adapted to be used. Furthermore, even though these inventions may be suitable for specific individual purposes, they would not be suitable for the objectives of the present invention.

### SUMMARY OF THE INVENTION

The object of the present invention is to give a disabled person who is confined to a wheelchair, or a bed, true control over his/her surroundings. The present invention permits the control of remote devices from the wheelchair, or bed, using electronic wireless means.

The present invention has a wireless communication device associated with the platform that the disabled person is confined to. This platform is typically a wheelchair. In an alternate embodiment the platform that the disabled person is confined to is a bed. Importantly, the disabled person is surrounded with remote pieces of equipment that are outfitted for communication with the wireless device housed in the platform.

In a preferred embodiment the wireless communication device is permanently build into the platform. The present invention allows for several embodiments for the wireless communication device. In one embodiment the wireless communication device is a based on a mobile telephone. This means that the wireless communication device is either a suitable mobile telephone which is equipped with the right communication protocols and software, or a mobile telephone that is appropriately modified for the needs of serving as a wireless communication device. These modifications include communication upgrades and physical alteration for associating the device with the platform. The mobile telephone can fit into an appropriate receptacle in the platform, or preferably it is manufactured into the platform. In another embodiment the wireless communication device is based on a personal digital assistant (PDA). Again, in a preferred embodiment the PDA based device is permanently manufactured into the platform. In yet another embodiment the wireless communication device is a computer, and the computer too in one embodiment is permanently built into the platform. In yet another embodiment, the wireless communication device needs not to be classified as identical, or similar to any other device. It is built for the intended purpose of the present invention.

It is possible that the disabled person is not only impaired in locomotion, but has problems using the upper extremities, as well. Accordingly, in one embodiment the wireless communication device is voice controlled. Standard voice recognition software is readily available, and is suitable for the purposes of the present invention. An example is ViaVoice manufactured by the IBM Corporation. In an alternate embodiment the wireless communication device is controlled through a joystick. An example of a joystick for use by the disabled is taught in U.S. Pat. No. 3,795,281 to Cloran, incorporated herein by reference.

It is important in the present invention that the wireless communication device is enabled to use one of several standard protocols for wireless communications. The standard wireless protocols are typically infrared, or radio communication protocols. In an infrared embodiment the wireless technology used can be an Infrared Data Association (IrDA) protocol, such as IrDA-Data, IrDA-Control, AIr, or the like. The Infrared Data Association was founded as a non-profit organization in 1993. IrDA is an International Organization that creates and promotes interoperable, low cost infrared data interconnection standards that support a walk-up, point-to-point user model. The standards support a broad range of appliances, computing and communications devices. IrDA has a large number of international companies as members. The preferred embodiment for radio communication is “Bluetooth” technology. This technology is a radio frequency specification for short-range, point-to-multipoint and point-to-point voice and data transfer. The Bluetooth technology makes all connections quickly, and operates in a globally available frequency band, ensuring compatibility worldwide. The Bluetooth technology provides a very high transmission rate. All data are protected by advanced error correction methods, as well as encryption. The Bluetooth technology is described in detail in the book: “Bluetooth Revealed” by Brent A. Miller, and Chatschik Bisdikian Prentice Hall; ISBN: 0130902942, incorporated herein by reference.

The wireless communication device is in communication using the appropriate protocol with remote pieces of equipment that surround the disabled person. These remote pieces of equipment are outfitted for communication with the wireless device. The various remote equipment devices each house their own wireless communicator to interact with the one associated with the platform. Each is enabled to use the appropriate protocol in either the radio, or the infrared embodiment. These remote communicators can be simpler implements then the one of the platform. Each of the remote communicators has to communicate with only one device, namely the one associated with the platform. The remote communicators receive the commands of the person, and each translates these commands into appropriate control sequences of the individual remote pieces of equipment.

The remote pieces of equipment comprise the whole surrounding of the person. They include apparatus pieces such as entertainment systems: television set, radio, VCR, CD player, video disk player etc. Further examples of the remote pieces of equipment are security related, such as doors, door locks, light switches, temperature control, alarms, etc. The wireless communication device can interact with other computing devices that the disabled person possesses, such as a personal computer. Yet other examples of the remote pieces of equipment are household appliances, like kitchen devices: oven, microwave oven, dishwasher, refrigerator, etc. Yet further examples of the remote equipment are transportation related devices, such as a car, van, boat etc.

Since the wireless communicator device has to communicate with a potentially large number or remote pieces of equipment it is important to have a well defined selection policy regarding which specific remote device will be receiving information, commands etc. There are several details comprising this policy in the present invention. In one case the communication occurs based on the distance of the remote equipment. Typically the nearest to the platform is selected. The disabled person can switch the policy, and communicate with the remote equipment based on previous usage statistics. In this case typically the first to answer would be the one that was involved in the last communication. In yet another case the condition of the disabled person, such as the wheelchair location, would determine the choice of remote piece of equipment for communication. In a further case, the choice of the remote piece of equipment is made through a menu selection.

The present invention allows the use of the wireless communication device for the disabled person to become part of a network. Persons of similar situation can be connected, for instance using a Bluetooth piconet. In some settings, for instance in a home for invalid people, such a net is useful beyond communication, to keep track of the whereabouts, and of the needs of the disabled persons. One can infer their needs through their latest communications. This way the security and comfort of the disabled person can be assured. The wireless communication device also allows connection to the Internet.

### BRIEF DESCRIPTION OF THE DRAWINGS

These and other features of the present invention will become apparent from the accompanying detailed description and drawings.

FIG. 1. shows the wireless communication device associated with various platforms for the disabled person.

FIG. 2. shows communication between the wireless communication device and various remote pieces of equipment.

FIG. 3. shows networking of wireless communication devices.

### DETAILED DESCRIPTION OF THE INVENTION

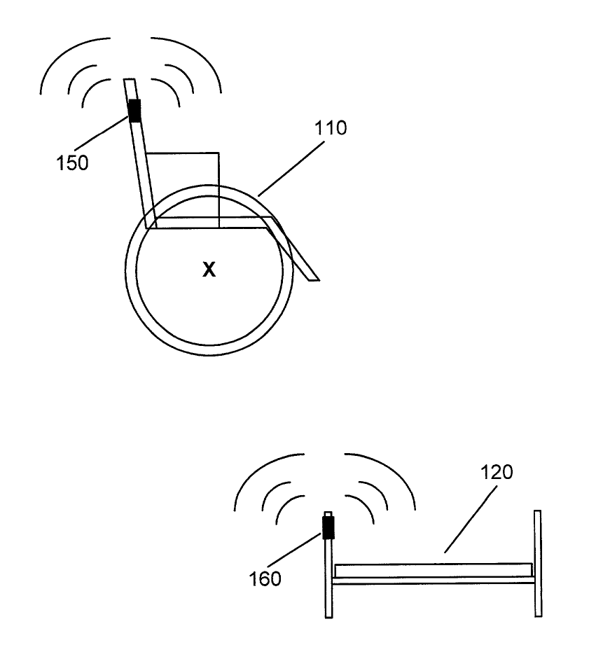

FIG. 1 shows an essential piece of the present invention, various platforms to which the disabled person is likely to be confined to. In a preferred embodiment this platform is a wheelchair 110. In an alternate embodiment the platform is a bed 120. A disabled person typically is in possession of both 110 and 120. In this manner the disabled person never has to be without communication means. A wireless communication device 150 is associated with the wheelchair, and another is associated with the bed 160.

The main feature is that the wireless communication devices 150 and 160 are both associated with the platforms. The association of devices 150 and 160 with the platform mean that the devices and the platform are planned and built in coordination with each other. In a preferred embodiment they are actually permanently built into the platform. In this manner the wireless communication device is optimized for use by disabled person and it is always available for the disabled person. The wireless communication devices 150 and 160 in the different platforms each can be based on devices of the same technology such as mobile telephone, or they each can be based on devices of different technologies, for instance one on mobile telephones while the other on computer technology.

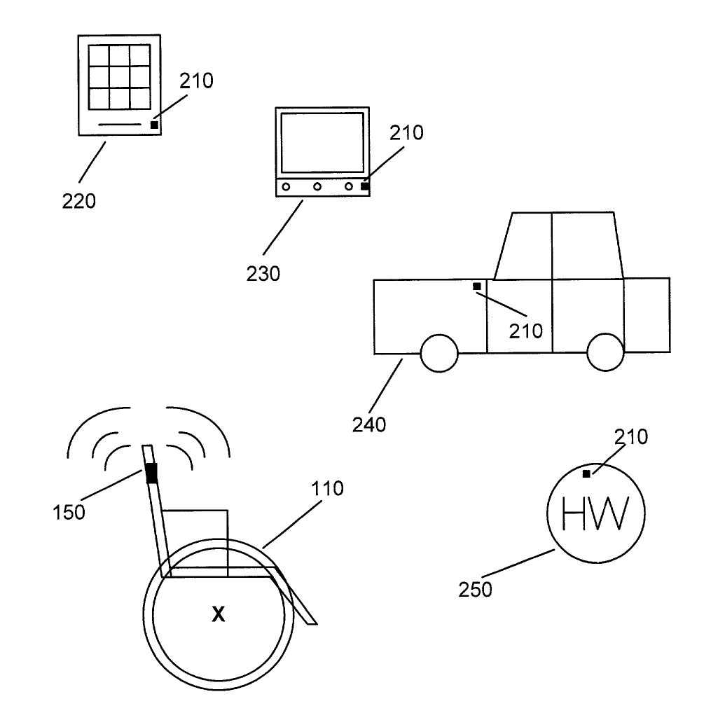

FIG. 2 shows main aspects of the present invention. The figure has the platform, in this case a wheelchair 110, housing the wireless communication device 150, together with various examples of remote pieces of equipment that constitute the surroundings of the disabled person. Each remote piece of equipment has itself a communication tool 210 to interact with the wireless communication device housed in the platform. The remote communicators 210 communicate with the wireless communication device housed in the platform using a standard protocol such as Bluetooth in case of radio communication and IrDA in case infrared communication. The remote communicators 210 receive commands from the disabled person, and then control their respective piece of remote equipment to act accordingly to the orders. Examples of remote pieces of equipment comprise security devices 220; entertainment apparatus 230, such as TV, CD player, VCR, etc.; devices related to transportation 240, such as an automobile, boat etc.; and general household appliances, such as hot water heater 250, oven, microwave oven, water faucets, etc.

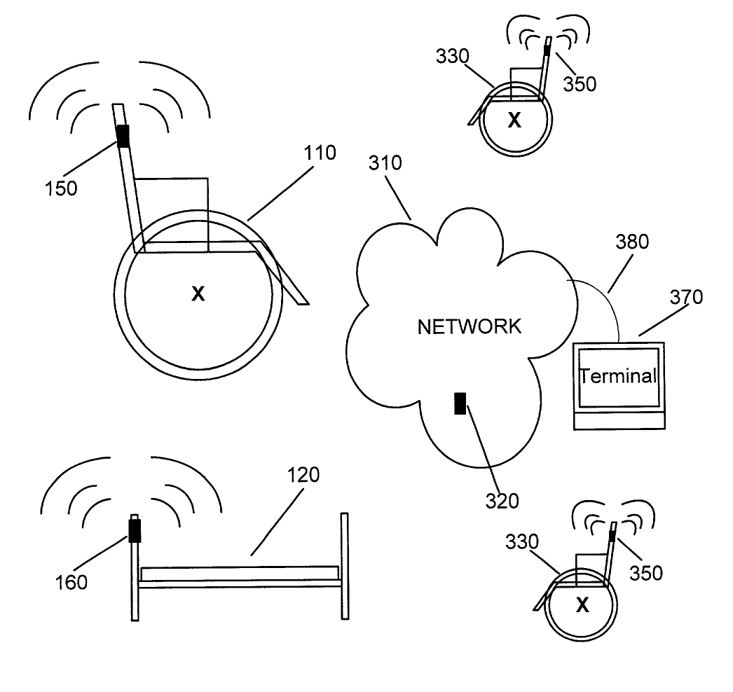

FIG. 3 shows the wireless communication devices as part a network. The wireless communication devices 150 and 160 of the disabled person connect wirelessly to a network 310, from either platform 110 and 120. The connection to the network follows the same protocol as communication with the remote pieces of equipment, e.g. Bluetooth, or IrDA. The network connection has a standard interface 320 for communication. Other platforms also connect to the network 310. In the figure, wheelchairs are depicted 330, with their own wireless communication devices 350. The network can be the Internet, or a local area network, such as a Bluetooth piconet. The advantages of networking are obvious. Disabled persons can communicate and keep track of each other. In certain settings such as in a home for the disabled, the network may be administered centrally by the caretakers of home. This can occur again through wireless means, or through a conventional connection 380 with a computer terminal 370. The central connection can register constantly the whereabouts and the states of each individual disabled person. The state, or condition, and potential emergencies regarding the disabled person can thus conveniently be monitored.

Many modifications and variations of the present invention are possible in light of the above teachings, and could be apparent for those skilled in the art. The scope of the invention is defined by the appended claims.

We claim:

1. A system for a person with limited mobility, comprising:
a platform, wherein the person is confined thereto;
a wireless communication device associated with the platform; and
one or more remote pieces of equipment, wherein the one or more remote pieces of equipment are outfitted for communication with the wireless communication device associated with the platform.

2. The system of claim 1 wherein the person is a disabled person.

3. The system of claim 1 wherein the platform is a wheelchair.

4. The system of claim 1 wherein the platform is a bed.

5. The system of claim 1, wherein the wireless communication device associated with the platform is permanently built into the platform.

6. The system of claim 1, wherein the wireless communication device is based on a mobile telephone.

7. The system of claim 1, wherein the wireless communication device is based on a personal digital assistant.

8. The system of claim 1, wherein the wireless communication device is a computer.

9. The system of claim 1, wherein the wireless communication device is voice controlled.

10. The system of claim 1, wherein the wireless communication device is controlled by a joystick.

11. The system of claim 1, wherein the one or more remote pieces of equipment comprise a security system.

12. The system of claim 1, wherein the one or more remote pieces of equipment comprise one or more entertainment apparatus.

13. The system of claim 1, wherein the one or more remote pieces of equipment comprise one or more transportation devices.

14. The system of claim 1, wherein the one or more remote pieces of equipment comprise one or more household appliances.

15. The system of claim 1, wherein the wireless communication device associated with the platform uses a standard protocol for wireless communication.

16. The system of claim 15, wherein the wireless communication device associated with the platform uses radio frequency for communication.

17. The system of claim 16, wherein the wireless communication device associated with the platform uses Bluetooth technology.

18. The system of claim 15, wherein the wireless communication device associated with the platform uses infrared frequency for communication.

19. The system of claim 18, wherein the wireless communication device associated with the platform uses Infrared Data Association technology.

20. The system of claim 1, wherein the wireless communication device associated with the platform connects wirelessly to a network.

21. The system of claim 20, wherein a state of the person is monitored using the network.

22. The system of claim 1, wherein the wireless communication device associated with the platform selects a specific piece of equipment for communication from the one or more remote pieces of equipment based on a selection policy.

23. The system of claim 22, wherein the policy comprise selecting the specific piece of equipment for communication from the one or more remote pieces of equipment based the proximity of the specific piece of equipment to the platform.

24. The system of claim 22, wherein the policy comprise selecting the specific piece of equipment for communication from the one or more remote pieces of equipment based on a usage history of the one or more remote pieces of equipment.

25. The system of claim 22, wherein the policy comprise selecting the specific piece of equipment from the one or more remote pieces of equipment based a condition of the person.

26. A system for a wheelchair bound person, comprising:
a wireless communication device permanently built into the wheelchair;
one or more remote pieces of equipment, wherein the one or more remote pieces of equipment are outfitted for communication with the wireless communication device;
a standard protocol for communication; and
a selection policy adopted by the wireless communication device for selecting a specific piece of equipment for communication from the one or more remote pieces of equipment.

27. The system of claim 26, wherein the wireless communication device uses radio frequency for communication.

28. The system of claim 27, wherein the wireless communication device associated with the platform uses Bluetooth technology.

29. The system of claim 26, wherein the wireless communication device uses infrared frequency for communication.

30. The system of claim 29, wherein the wireless communication device associated with the platform uses Infrared Data Association technology.

31. A method for helping wheelchair bound persons to control their surroundings, comprising the steps of:
providing a wireless communication device permanently built into the wheelchair;
supplying one or more remote pieces of equipment, wherein the one or more remote pieces of equipment are outfitted for communication with the wireless communication device;
using a standard protocol for communication; and
providing a selection policy adopted by the wireless communication device for selecting a specific piece of equipment for communication from the one or more remote pieces of equipment.

32. The method of claim 31, wherein the wireless communication device uses radio frequency for communication.

33. The method of claim 32, wherein the wireless communication device associated with the platform uses Bluetooth technology.

34. The method of claim 31, wherein the wireless communication device uses infrared frequency for communication.

35. The method of claim 34, wherein the wireless communication device associated with the platform uses Infrared Data Association technology.

36. A computer data signal embodied in a carrier wave encoding a computer program of instructions for executing a computer process performing the steps for helping a wheelchair bound person as recited in the steps of claim 31.
